(19) United States
(12) Patent Application Publication
(10) Pub. No.: US 2026/0326715 A1
(43) Pub. Date: Oct. 22, 2026

(54) SELF-CALIBRATED UWB MODULES FOR A VEHICLE ACCESS SYSTEM

(71) Applicant: SCHAEFFLER TECHNOLOGIES AG & CO. KG, Herzogenaurach (DE)

(72) Inventors: Vincent MARIMOUTOU, Toulouse (FR); Maxime RATEAU, Toulouse (FR); Olivier GERARDIERE, Toulouse (FR)

(21) Appl. No.: 19/122,975

(22) PCT Filed: Nov. 28, 2023
(86) PCT No.: PCT/EP2023/083279

§ 371 Date: Apr. 21, 2025

(30) Foreign Application Priority Data
Dec. 1, 2022 (FR) 2212611

(51) Int. Cl. B60R 25/24; B60R 25/31; G01S 13/02; G01S 13/76

(52) U.S. Cl. CPC B60R 25/245; B60R 25/31; G01S 13/0209; G01S 13/765

(57) ABSTRACT

A set (100) of at least two UWB modules (110₁; 110₂; 110₃; 110₄), in which each UWB module comprises a respective transceiver, a respective time stamper, and a respective signal processor.

Each UWB module is capable of computing a current value of the distance between said UWB module and a keycard.

Each UWB module is further capable of computing the value of a calibration distance, using a bidirectional communication with the other UWB modules, a time-of-flight computation and computation of a difference between a measured distance and an actual distance between two UWB modules.

### TECHNICAL FIELD

The invention relates to the field of vehicle access systems.

A vehicle access system is embedded in a motor vehicle. It is capable of exchanging information with at least one keycard carried by a user wishing to access said vehicle, so as to be able to authenticate and locate said user.

### PRIOR ART

In a manner known per se, a vehicle access system conventionally comprises:
a central computer;
long-range transceiving means, which are advantageously based on so-called BLE technology, BLE standing for Bluetooth Low Energy, and which interact with the central computer with a view to remotely detecting and authenticating a keycard-carrying user permitted to access the vehicle;
medium-range transceiving means, which are advantageously based on so-called UWB technology, UWB standing for Ultra-Wide Band, and which interact with the central computer with a view to locating the authenticated user, and to activating certain functions of the vehicle depending on the position of the user (for example, activating lighting of the vehicle on entry into a first perimeter, then unlocking the doors on entry into a second perimeter narrower than the first perimeter); and
where appropriate, short-range presence-detecting means, which are capable of detecting the immediate proximity of the authenticated user, and which interact with the central computer with a view to activating at least one door-unlocking function of the vehicle.

Throughout this text, the term UWB (which stands for Ultra-Wide Band) refers to a radio-frequency signal of low energy and large spectral width. In particular, a UWB radio-frequency signal is defined by a ratio of bandwidth to central frequency greater than or equal to 20%, or by a bandwidth of 250 MHz or more.

The medium-range transceiving means in particular comprise a set of UWB modules intended to be positioned, in use, at predetermined positions on the vehicle.

Each UWB module preferably comprises:
a transceiver, configured to transmit a UWB keycard interrogation signal, and to receive in return a UWB keycard response signal;
a time stamper, configured to store timestamp data, relating to the times of transmission of the keycard interrogation signal and of reception of the keycard response signal; and
a signal processor, configured to compute a current value of the distance between said UWB module and the keycard, using said timestamp data.

In a manner known per se, each keycard response signal further incorporates timestamp data stored in the keycard. This allows the signal processor to accurately determine a time of radio-frequency signal propagation between the UWB module and the keycard, even if the clocks of the keycard and of the UWB module are not perfectly synchronized.

In any case, the signal processor is configured to determine a time of radio-frequency signal propagation between the UWB module and the keycard, called the time of flight. This time of flight makes it possible to determine a current value of the distance between the UWB module and the keycard, these two quantities being related by the speed of light in vacuum, or more particularly the speed of a radio wave in air.

In particular:

dₘₑₛ=c*Δt+d_{cal}, with
dₘₑₛ the current value of the distance between the UWB module and the keycard;
c the speed of light in vacuum;
Δt said time of flight; and
d_{cal} a calibration distance specific to the UWB module and in particular related to slight delays introduced by the UWB module itself.

In a known manner, the calibration distance d_{cal} is computed in the factory, before installation of the UWB module in the vehicle, and stored in a memory, within said UWB module. In use, the calibration distance d_{cal} is used by the signal processor to compute current values of the distance between said UWB module and the keycard.

In use, each of the UWB modules determines a current value of the distance to the keycard. These multiple distance values are transmitted to the central computer, which determines the position of the keycard via a triangulation computation.

One objective of the present invention is to provide a solution allowing the accuracy with which the position of the keycard is determined to be improved.

### SUMMARY OF THE INVENTION

This objective is achieved with a set of at least two (preferably at least three) modules called UWB modules, in which each UWB module comprises a respective transceiver, a respective time stamper, and a respective signal processor, and, in each UWB module:
the transceiver is configured to transmit and receive ultra-wideband radio-frequency signals, in particular in order to transmit a keycard interrogation signal, and to receive in return a keycard response signal from a keycard;
the time stamper is configured to store first timestamp data, relating to the times of transmission of the keycard interrogation signal and of reception of the keycard response signal; and
the signal processor is configured to use said first timestamp data to compute a first current time-of-flight value, corresponding to a time of radio-frequency signal propagation between said UWB module and the keycard, and to then compute a current value of the distance between said UWB module and the keycard.

According to the invention, in each UWB module:
the transceiver is further configured to transmit a UWB-module interrogation signal, to at least one of the other three UWB modules, and to receive in return at least one UWB-module response signal (from at least one of the other three UWB modules);
the time stamper is configured to store second timestamp data, relating to times of transmission of the UWB-module interrogation signal and of reception of the UWB-module response signal;
the signal processor is configured to use said second timestamp data to compute at least one second current time-of-flight value, each corresponding to a time of radio-frequency signal propagation between said UWB module and a respective one of the other three UWB modules, and then to deduce therefrom at least one current value of the distance between said UWB module and said other UWB module, called the measured separation;
the signal processor comprises a memory, storing at least one actual separation value, each corresponding to an actual value of the distance between said UWB module and a respective one of the other three UWB modules; and
the signal processor is configured to compute the value of a calibration distance, using the at least one measured separation and the at least one actual separation value.

In other words, each UWB module is capable of:
computing a current value of the distance between said UWB module and a keycard, using a bidirectional communication with said keycard; and
computing the value of a calibration distance, using a bidirectional communication with the other UWB modules, a time-of-flight computation and computation of a difference between a measured distance and an actual distance between two UWB modules.

Thus, each UWB module is capable of self-calibrating, i.e. computing itself the calibration distance value associated with the distance computations it performs.

The self-calibration according to the invention does not require particular conditions to be met, such as a link to an external calibration apparatus during a maintenance operation. In other words, the self-calibration according to the invention is capable of being repeated as many times as desired over time. It is thus possible to update, throughout the lifetime of the UWB modules, their respective calibration distances. It is thus possible to account, in the distance computations provided by each UWB module, for potential drift in the calibration distance associated with said UWB module. This drift may be due to the effects of aging and wear of materials, slight shifts in the physical positions of the module elements, etc.

At any given time, the calibration distance used to compute a distance using the UWB module is therefore very close to an actual calibration distance value. The error in the distance computation is therefore minimized, and consequently the error in the determination of the position of the keycard.

The invention thus offers a solution allowing the accuracy with which the position of the keycard is determined to be improved, in a system determining the position of the keycard using distance measurements provided by each of the UWB modules of the set according to the invention.

The self-calibration uses at least one other of the UWB modules present on the vehicle, each of these UWB modules being placed in a fixed and known position on the vehicle. Thus, the self-calibration does not require the addition of additional dedicated elements. Compactness and manufacturing costs are thus optimized.

Lastly, the self-calibration is carried out completely autonomously by each UWB module. In particular, the self-calibration does not involve any additional exchange of data, between a UWB module and the central computer, in comparison with the prior art. The invention may thus be implemented using a central computer identical to those of the prior art, without any adaptation being necessary.

In particular, each UWB module is capable of carrying out the self-calibration on its own initiative, at predetermined times (for example each time it switches from a standby mode to an active mode).

Two UWB modules may exchange a plurality of UWB-module interrogation signals and a plurality of UWB-module response signals. In addition or as a variant, transmission of the interrogation signal may be preceded by reception of a wake-up signal, from the UWB module with which a bidirectional communication is then set up.

Preferably, each UWB-module response signal incorporates what are called additional timestamp data, stored and then incorporated into the signal in the UWB module transmitting said response signal. Each UWB module is then capable of:
extracting these additional timestamp data, from the response signal that it receives, and
also using these additional timestamp data to compute the second current time-of-flight value.

The additional timestamp datum advantageously relates to a time interval between reception of a UWB-module interrogation signal and transmission in return of a UWB-module response signal, within the same UWB module. It is thus possible to accurately determine a propagation time between two UWB modules, even if their respective clocks are not perfectly synchronized.

Preferably, in each UWB module, the signal processor is configured to compute the value of the calibration distance, using a difference between the measured separation and the actual separation value.

Advantageously, in each UWB module:
said memory stores a plurality of actual separation values, which respectively correspond to the actual values of the separation between said UWB module and each of the other UWB modules;
said UWB module is configured to compute a plurality of measured separations, which correspond to respective values of the distance between said UWB module and each of the other UWB modules; and
said UWB module is configured to compute the value of a calibration distance, using respective differences between a measured separation and a corresponding actual separation value, and combining said differences.

In each UWB module, the signal processor is configured to store said calibration distance value, and to use the latter during subsequent computations of a current value of the distance between said UWB module and the keycard.

In each UWB module, the signal processor may be configured to:
determine an initial calibration distance value, then use the latter as a calibration distance value, during subsequent computations of a current value of the distance between said UWB module and the keycard; then
determine at least one updated calibration distance value, then use the latter as a calibration distance value, during subsequent computations of a current value of the distance between said UWB module and the keycard.

Advantageously, each UWB module has what is called a conventional operating mode, in which it is configured to provide at least one current distance value relative to a keycard, and what is called a self-calibration operating mode, in which it is configured to provide a calibration distance value, each UWB module further comprising a control unit configured to switch the UWB module to the self-calibration mode.

Advantageously, in each UWB module, the signal processor is configured to compare the value of a calibration distance with a predetermined threshold value, and to generate a warning signal when the value of a calibration distance is greater than said threshold value.

In each UWB module, the signal processor may be configured to:
detect a faulty module among the UWB modules of the set, by comparing, with a predetermined threshold, a difference in absolute value between the measured separation and the corresponding actual separation value; and
deactivate the UWB module identified as being faulty, when the presence of a faulty module among the UWB modules of the set has been detected.

The invention also covers a system for locating a user, intended to be integrated into a motor vehicle, and comprising a set according to the invention, the system further comprising a central computer, connected to each of the UWB modules of the set, and configured to:
receive, from each respective one of said UWB modules, a current value of the distance between said UWB module and the keycard; and
compute, using said current distance values, a current position of the keycard relative to said vehicle.

Preferably, said central computer is further configured to lock and/or unlock at least one door of the motor vehicle, in particular depending on at least one current position of the keycard relative to said vehicle.

The system according to the invention may further comprise the keycard, the keycard being intended to be carried by a user wishing to access the motor vehicle, and the keycard comprising a memory storing an authentication code.

The invention also relates to a vehicle comprising a set according to the invention.

The invention also relates to a method implemented in each UWB module of a set according to the invention, the method comprising the following steps:
a/transmitting the UWB-module interrogation signal to at least one of the other three UWB modules and receiving in return the at least one UWB-module response signal;
b/storing the second timestamp data, relating to the times of transmission of the UWB-module interrogation signal and of reception of the UWB-module response signal;
c/using the second timestamp data, computing the second current time-of-flight value, corresponding to a time of radio-frequency signal propagation between said UWB module and a respective one of the other three UWB modules, and using said second current time-of-flight value to compute the corresponding measured separation;
d/computing a difference between the measured separation and the corresponding actual separation value, to obtain a calibration distance value; then
e/using said calibration distance value to subsequently compute at least one current value of the distance between said UWB module and a keycard.

Advantageously, steps a/to d/are implemented a plurality of times during the lifetime of the set according to the invention, and step e/is implemented each time using the last computed calibration distance value.

The process according to the invention may further comprise:
a step of detecting a faulty module among the UWB modules of the set, by comparing, with a predetermined threshold, a difference in absolute separation between the measured separation and the corresponding actual separation value; and
a step of deactivating the UWB module identified as being faulty, when the presence of a faulty module among the UWB modules of the set has been detected.

### DESCRIPTION OF THE FIGURES

Further features and advantages of the invention will become more apparent upon reading the following description. This description is purely illustrative and should be read with reference to the appended drawings, in which:

FIG. 1 schematically illustrates a set and a system according to the invention, integrated into a motor vehicle;

FIG. 2 schematically illustrates the set of FIG. 1, and, for one of the UWB modules of the set, the bidirectional communications that exist with the other UWB modules of the set;

FIG. 3 schematically illustrates a UWB module in a set according to the invention; and

FIG. 4 schematically illustrates a method implemented within a UWB module in a set according to the invention.

### DETAILED DESCRIPTION OF AT LEAST ONE EMBODIMENT

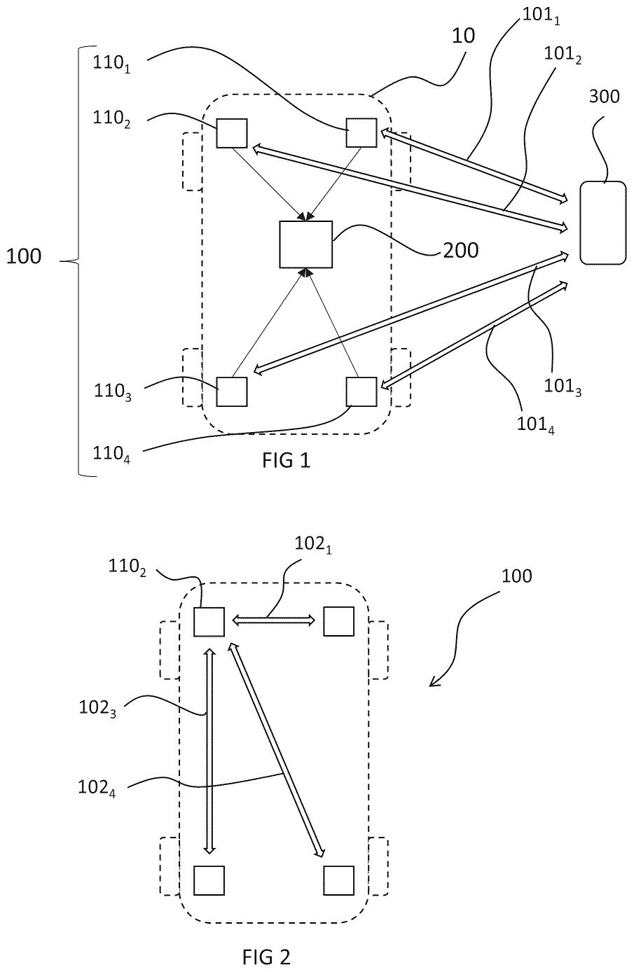

First of all, a set 100 according to the invention will be described schematically and with reference to FIG. 1.

The set 100 is made up of a plurality of UWB modules, or anchors, here four UWB modules referenced 110₁, 110₂, 110₃ and 110₄.

In use, the four UWB modules are integrated into a motor vehicle 10, drawn in dashed lines and seen from above in FIG. 1. The four UWB modules are more particularly each placed at one of the four corners of the motor vehicle 10 (the four corners being defined on a representation of the vehicle seen from above).

Each of the four UWB modules will be described in greater detail below.

FIG. 1 also illustrates a central computer 200, embedded in the motor vehicle 10, and a keycard 300, intended to be carried by a user wishing to gain access to the interior of the motor vehicle 10.

In use, each of the four UWB modules 110₁, 110₂, 110₃ and 110₄ is capable of exchanging UWB radio-frequency signals with the keycard 300. The bidirectional communication between the keycard 300 and each of the respective UWB modules 110₁, 110₂, 110₃ and 110₄ has been symbolized, in FIG. 1, by respective arrows 101₁, 101₂, 101₃, 101₄.

This exchange of signals allows each UWB module to determine its distance from the keycard 300, by computing a time of flight. Each of the UWB modules transmits this distance to the central computer 200, which determines, by triangulation, the position of the keycard 300 relative to the vehicle 10. The UWB modules 110₁, 110₂, 110₃ and 110₄ thus form, with the computer 200, a locating system. Where appropriate, the locating system may be defined as also incorporating the keycard 300.

The keycard 300 may be a dedicated device, or it may be formed by a smartphone equipped with a dedicated application. In any case, the keycard 300 is configured to receive, process and transmit UWB radio-frequency signals, allowing the UWB modules to compute times of flight to said keycard.

Advantageously, the keycard 300 further comprises a memory, which stores an authentication code capable of being recognized by the central computer 200.

Advantageously, the keycard 300 is further configured to transmit and receive radio-frequency signals in a technology other than UWB, in particular the long-range radio-frequency transmission technology BLE. This long-range transmission may be used for an exchange of data relating to the aforementioned authentication code.

The central computer 200 is embedded in the vehicle 10. It comprises elements such as at least one processor associated with one or more memories. It is configured to exchange data with, at least, each of the four UWB modules 110₁, 110₂, 110₃ and 110₄.

The central computer 200 may have many functionalities other than just locating the keycard 300. For example, it may be configured to lock and/or unlock at least one door of the motor vehicle 10, depending in particular on at least one current position of the keycard 300 and on an authentication code transmitted by the latter. In other words, the central computer 200 and the four UWB modules 110₁, 110₂, 110₃ and 110₄ then belong to a vehicle access system, preferably a passive system.

According to the invention, and as illustrated in FIG. 2, each of the four UWB modules 110₁, 110₂, 110₃ and 110₄ is further capable of exchanging UWB radio-frequency signals with each of the other three UWB modules. In particular:
the first UWB module 110₁ is capable of exchanging UWB signals with each of the three UWB modules 110₂, 110₃ and 110₄;
the second UWB module 110₂ is capable of exchanging UWB signals with each of the three UWB modules 110₁, 110₃ and 110₄;
the third UWB module 110₃ is capable of exchanging UWB signals with each of the three UWB modules 110₂, 110₁ and 110₄; and
the fourth UWB module 110₄ is capable of exchanging UWB signals with each of the three UWB modules 110₂, 110₃ and 110₁.

In FIG. 2, the bidirectional communication between the second UWB module 110₂ and each of the three UWB modules 110₁, 110₃ and 110₄ has been represented using three arrows 102₁, 102₃, 102₄.

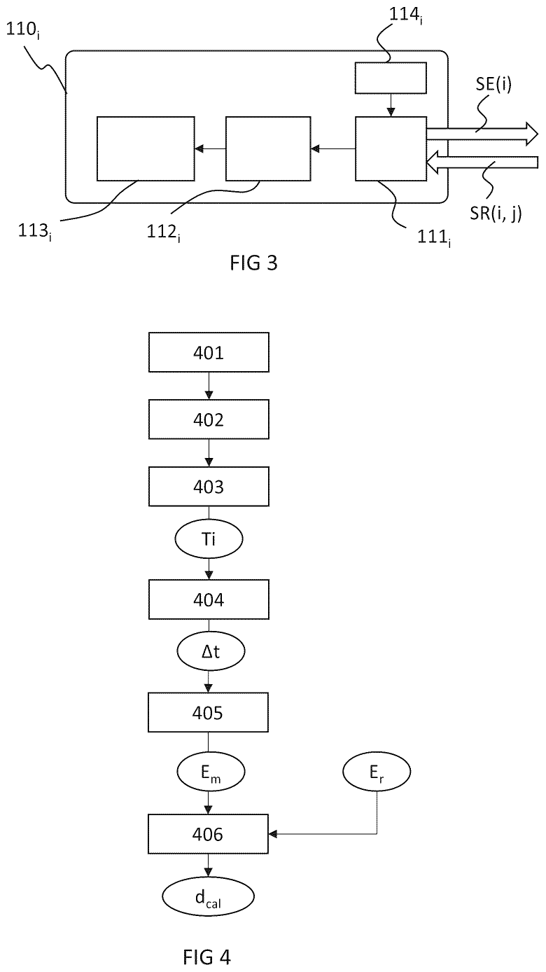

FIG. 3 then illustrates, schematically, a UWB module 110_{i=1, 2, 3 or 4} of the set 100 according to the invention.

Each UWB module 110_{i=1, 2, 3 or 4} of the set 100 according to the invention comprises:
a transceiver 111_{i=1, 2, 3 or 4};
a time stamper 112_{i=1, 2, 3 or 4}; and
a signal processor 113_{i=1, 2, 3 or 4}.

The transceiver 111_{i=1, 2, 3 or 4} is configured to transmit and receive UWB radio-frequency signals. For this purpose, it in particular comprises an electronic oscillator and at least one radio-frequency antenna capable of converting an electrical signal into a radio-frequency signal, and vice versa.

Here, the transceiver 111_{i=1, 2, 3 or 4} is more particularly configured to:
transmit at least one keycard interrogation signal, to a keycard such as the keycard 300 of FIG. 1;

receive at least one keycard response signal, from in use a keycard having received said keycard interrogation signal;

transmit at least one UWB-module interrogation signal, referenced SE(i) in FIG. 3, where i refers to the transmitting UWB module; and
receive at least one UWB-module response signal, referenced SR(i, j) in FIG. 3, where i relates to the UWB module transmitting the interrogation signal and j relates to the UWB module transmitting the response signal.

In other words, in addition to their ability to exchange signals with the keycard, the UWB modules of the set according to the invention are connected in a network.

The keycard interrogation signal and the keycard response signal are not shown in FIG. 3, and correspond to the UWB signals transmitted by prior-art UWB modules.

The UWB-module interrogation signal is a UWB radio-frequency signal. It may be sent in turn to each of the other three UWB modules. As a variant, the UWB-module interrogation signal is sent simultaneously in a plurality of spatial directions, so as to be able to be received by each of the other three UWB modules.

The UWB-module interrogation signal may have characteristics similar to those of the keycard interrogation signal, the difference being that:
during transmission of the keycard interrogation signal, the other UWB modules are placed in a mode in which they do not react to reception of such a signal, whereas
during transmission of the UWB-module interrogation signal, the other UWB modules are placed in a mode in which they react to reception of such a signal.

The UWB-module response signal is a UWB radio-frequency signal. It may be similar to a keycard response signal. The UWB-module response signal is transmitted by another of the UWB modules of the set according to the invention, on reception of the UWB-module interrogation signal.

Thus, in each UWB module, the transceiver 111_{i=1, 2, 3 or 4} is capable of:
receiving at least one UWB-module response signal from another of the UWB modules in the set, but also
transmitting such a UWB-module response signal, on reception of a UWB-module interrogation signal from another of the UWB modules of the set.

In other words, in each UWB module, the transceiver 111_{i=1, 2, 3 or 4} is capable of carrying out a bidirectional communication with the other UWB modules. This bidirectional communication involves the exchange of at least one interrogation signal and response signal. A wake-up signal, sent by one UWB module to another UWB module to set up the bidirectional communication, may also be employed.

In practice, the transceiver 111_{i=1, 2, 3 or 4} may receive, simultaneously or not, a UWB-module response signal from each of the other three UWB modules of the set.

The time stamper 112_{i=1, 2, 3 or 4} is connected to the transceiver 111_{i=1, 2, 3 or 4}. It is configured to store:
first timestamp data, relating to the times of transmission of the keycard interrogation signal and of reception of the keycard response signal (as in the prior-art UWB modules); and
second timestamp data, relating to the times of transmission of a UWB-module interrogation signal, denoted SE(i), and of reception of a UWB-module response signal, denoted SR(i, j), transmitted by another of the UWB modules and in response to reception of the signal SE(i).

The second timestamp data may relate to the respective times of reception of the UWB-module response signal, from each of the other three UWB modules.

The time stamper 112_{i=1, 2, 3 or 4} may comprise its own memory, in which the timestamp data are stored. As a variant, it writes data directly to the signal processor 113_{i=1, 2, 3 or 4}.

In any case, the signal processor 113_{i=1, 2, 3 or 4} is connected to the time stamper 112_{i=1, 2, 3 or 4}, so as to be able to receive the first and second timestamp data.

Advantageously, at least some of the second timestamp data may be encoded in, or incorporated into, a UWB-module response signal transmitted by said module.

The signal processor 113_{i=1, 2, 3 or 4} is configured to be able to implement a first signal-processing operation and a second signal-processing operation. It advantageously comprises at least one microcontroller.

In one advantageous embodiment, the transceiver 111_{i=1, 2, 3 or 4}, the time stamper 112_{i=1, 2, 3 or 4} and the signal processor 113_{i=1, 2, 3 or 4} are integrated together into the same printed circuit board. This removes the need for connecting cables between these elements, liable to cause additional delays.

The first signal-processing operation is similar to the one employed in the prior art. It consists in:
using the first timestamp data to compute a first current value of the time of flight between the UWB module 110ᵢ and a keycard such as the keycard 400 of FIG. 1, the first current time-of-flight value corresponding to a time of radio-frequency signal propagation between said UWB module 110ᵢ and the keycard; then
using said time of flight, computing a current value of the distance between said UWB module 110ᵢ and the keycard.

Advantageously, computation of the first current time-of-flight value also uses additional timestamp data extracted from the keycard response signal. These data preferably relate to time intervals between signal reception and signal transmission, by the keycard.

In a manner known per se, the current distance value is given by:

dB(t)=Δt₁(t)*c+d_{cal}, with

dB(t) the value of the distance between said UWB module 110ᵢ and the keycard, at the time t;

C the Speed of Light in Vacuum;

Δt₁(t) the first time-of-flight value, at the time t; and

d_{cal} a predetermined calibration distance associated with the UWB module 110ᵢ.

The calibration distance d_{cal} is a value specific to the UWB module 110ᵢ in question. It generally takes a non-zero value, in particular because of various time delays that may be introduced within said UWB module.

The second signal-processing operation is original. It consists in:
using the second timestamp data to compute at least one second current value of the time of flight between the UWB module 110ᵢ and one of the other three UWB modules. Each second current time-of-flight value corresponds to a time of radio-frequency signal propagation between said UWB module 110ᵢ and one of the other three UWB modules; then
using the at least one time of flight, computing at least one current value of the distance between said UWB module 110ᵢ and one of the other three UWB modules. Each current distance value is called the measured separation.

Advantageously, computation of the second current time-of-flight value also uses additional timestamp data extracted from the UWB-module response signal. These additional timestamp data preferably relate to time intervals between reception of an interrogation signal and transmission of a response signal, by the UWB module sending said response signal. For this purpose, each UWB module is configured both to incorporate such data into a UWB-module response signal that it sends, and to extract such data from a UWB-module response signal that it receives.

The second signal-processing operation may include computing a plurality of second current time-of-flight values, respectively between the UWB module 110ᵢ and each of the other three UWB modules. It may then include computing a plurality of current distance values, respectively between the UWB module 110ᵢ and each of the other three UWB modules.

The signal processor 113_{i=1, 2, 3 or 4} comprises a memory (not specifically shown in FIG. 3) storing at least one actual separation value. Each actual separation value corresponds to the value of the actual distance between said UWB module 110ᵢ and a respective one of the other three UWB modules. These actual separation values are known data, related to the physical positions of the UWB modules, under the conditions of use. It is a question in practice of the actual distances between the UWB modules when they are mounted on a motor vehicle. The actual separation values may be standard data, common to every vehicle of a given model. As a variant, provision may be made for a preliminary step of measuring said actual separation values on one motor vehicle in particular, and of storing said measurements in the signal processor 113_{i=1,2, 3 or 4} of said vehicle.

The signal processor 113_{i=1, 2, 3 or 4} is further configured to compute a value of the calibration distance d_{cal}, using the at least one measured separation and the at least one actual separation value.

The value of the calibration distance d_{cal} is in particular dependent on at least one difference δⱼ, such that:

δⱼ=Eᵣ(j)−Δt₂(t; j)*c, with

E_{R}(j) the actual separation from the other UWB module of index j;

c the speed of light in vacuum; and

Δt₂(t; j) the second time-of-flight value, obtained at the time t and using a signal from the UWB module of index j, where Δt₂(t; j)*c corresponds to the value of the actual separation between the UWB module 110ᵢ and the UWB module 110ⱼ.

The value of the calibration distance d_{cal} is for example an arithmetic mean of the δⱼ obtained for each of the other three UWB modules 110ⱼ, and where appropriate for various measurement times. The average may be weighted, for example to give more weight to the actual separations least susceptible to error, etc.

In practice, each UWB module 110_{i=1, 2, 3 or 4} advantageously has two operating modes (in addition to a standby mode):
a mode called the “conventional” mode, in which it is configured to provide at least one current distance value relative to a keycard; and
a mode called the “self-calibration” mode, in which it is configured to provide a calibration distance value.

Preferably, each UWB module 110_{i=1, 2, 3 or 4} is capable of initiating itself a switch to self-calibration mode. In particular, each UWB module 110_{i=1, 2, 3 or 4} is capable of initiating itself the communication with the other UWB modules followed by subsequent steps making it possible, in the end, to determine a value of the calibration distance d_{cal}. In other words, each UWB module 110_{i=1, 2, 3 or 4} is capable of initiating implementation of the steps of the method according to the invention, as described below with reference to FIG. 4. Each UWB module 110_{i=1, 2, 3 or 4} is capable of making this switch at its own initiative, without external invitation, in particular by a central computer or an external calibration apparatus, or a smartphone.

To make this switch, each UWB module 110_{i=1, 2, 3 or 4} advantageously comprises a respective control unit 114_{i=1, 2, 3 or 4}. Each control unit 114_{i=1, 2, 3 or 4} is configured to initiate implementation of the steps of the method according to the invention, at predetermined times, for example each time the motor vehicle is started up.

In each UWB module, the control unit is therefore configured to control the following steps, at predetermined times:
transmitting at least one UWB-module interrogation signal and receiving at least one UWB-module response signal, by means of the transceiver;
storing corresponding second timestamp data, by means of the time stamper;
using the signal processor, computing at least one second current time-of-flight value, then at least one corresponding measured separation, and lastly a value of a calibration distance.

The steps of the method according to the invention, implemented in each UWB module 110ᵢ of the set according to the invention, will now be described with reference to FIG. 4.

In a first step 401, a UWB-module interrogation signal as described above is transmitted. This step 401 is implemented using the transceiver 111_{i=1, 2, 3 or 4}.

In a second step 402, at least one UWB-module response signal as described above is received. This step 402 is implemented using the transceiver 111_{i=1, 2, 3 or 4}.

These steps 401 and 402 may be repeated a plurality of times.

In a third step 403, the second timestamp data as described above, relating to the times of signal transmission in step 401 and of signal reception in step 402, are stored. This step 403 is implemented using the time stamper 112_{i=1, 2, 3 or 4}. It may be implemented at the same time as steps 401 and 402. In FIG. 4, the second timestamp data are denoted Ti.

In a fourth step 404, at least one second current time-of-flight value, as described above, is computed. This step 404 is implemented by means of the signal processor 113_{i=1, 2, 3 or 4}. In FIG. 4, the at least one time-of-flight value thus computed is denoted Δt.

In a fifth step 405, at least one measured separation as described above is computed. This step 405 is implemented by means of the signal processor 113_{i=1, 2, 3 or 4}. In FIG. 4, the at least one measured separation thus computed is denoted Eₘ.

In a sixth step 406, the difference between at least one measured separation Eₘ and a corresponding actual separation value Eᵣ as described above is computed, and a calibration distance value, as described above, is deduced therefrom. This step 406 is implemented by means of the signal processor 113_{i=1, 2, 3 or 4}. In FIG. 4, the calibration distance value is denoted d_{cal}.

The method then comprises a step (not shown) of updating the value of a constant.

This value d_{cal} is then used to update the value of a constant, stored in the signal processor 113_{i=1, 2, 3 or 4} and used as calibration distance to compute a current value of the distance between the UWB module 110ᵢ and a keycard. Thus, subsequent computations of a distance to a keycard will be based on the calibration distance value computed using steps 401 to 406 described above.

Advantageously, a new calibration distance value may be computed a plurality of times during the lifetime of each UWB module. Each time, this new calibration distance value is used to update the value of said constant. It is thus ensured that the effect of aging of each module is taken into account over time.

The invention is not limited to the examples described above, and also includes many other variants, for example with a different number of UWB modules in the set of modules. For example, the set may comprise only two UWB modules, each installed in use on a respective B-pillar of the vehicle. According to another variant, the set may comprise more than four UWB modules, with, in use, one UWB module in each corner of the vehicle and one or more UWB modules at the center or on a B-pillar of the vehicle.

It will be noted that a large increase in the calibration distance may indicate a malfunction of at least one of the UWB modules. In advantageous variants, the signal processor in each UWB module is configured to:
detect a faulty module among the UWB modules of the set, by comparing, with a predetermined threshold, a difference in absolute separation between the measured separation and the corresponding actual distance value; and
deactivate the UWB module identified as being faulty, when the presence of a faulty module among the UWB modules of the set has been detected.

In practice, a UWB module may control its own deactivation, or the deactivation of a third-party module.

For example, a UWB module, denoted A, computes measured separations E_{AB} and E_{AC} relative to a second UWB module, denoted B, and a third UWB module, denoted C, respectively.

If E_{AB} is very far from the actual value of the distance between modules A and B (beyond a first predetermined threshold), while E_{AC} is fairly close to the actual value of the distance between modules A and C (below a second predetermined threshold, different from or identical to the first predetermined threshold), then module B is considered to have malfunctioned and module A deactivates module B.

If E_{AB} is very far from the actual value of the distance between modules A and B (beyond a first predetermined threshold) and E_{AC} is also very far from the actual value of the distance between modules A and C (beyond a second predetermined threshold, different from or identical to the first predetermined threshold), then module A may itself be considered to have malfunctioned, and module A deactivates itself.

Deactivation of a UWB module is advantageously accompanied by transmission of a warning signal, intended to inform the user of the vehicle that maintenance is required.

1. A set (100) of at least two modules called UWB modules (110₁; 110₂; 110₃; 110₄; 110ᵢ) for a user-locating system intended to be integrated into a motor vehicle, in which each UWB module is intended to be positioned, in use, in a predetermined position on a motor vehicle, and comprises a respective transceiver (111ᵢ), a respective time stamper (112ᵢ), and a respective signal processor (113ᵢ), and, in each UWB module:
the transceiver (111ᵢ) is configured to transmit and receive ultra-wideband radio-frequency signals, in particular in order to transmit a keycard interrogation signal, and to receive in return a keycard response signal from a keycard (300);
the time stamper (112ᵢ) is configured to store first timestamp data, relating to the times of transmission of the keycard interrogation signal and of reception of the keycard response signal; and
the signal processor (113ᵢ) is configured to use said first timestamp data to compute a first current time-of-flight value, corresponding to a time of radio-frequency signal propagation between said UWB module and the keycard (300), and to then compute a current value of the distance between said UWB module and the keycard (300);
characterized in that, in each UWB module (110₁; 110₂; 110₃; 110₄; 110ᵢ):
the transceiver (111ᵢ) is further configured to transmit a UWB-module interrogation signal (SE(i)), to at least one of the other three UWB modules, and to receive in return at least one UWB-module response signal (SR(i, j));
the time stamper (112ᵢ) is configured to store second timestamp data (Ti), relating to times of transmission of the UWB-module interrogation signal (SE(i)) and of reception of the UWB-module response signal (SR(i, j));
the signal processor (113ᵢ) is configured to use said second timestamp data to compute at least one second current time-of-flight value (Δt), each corresponding to a time of radio-frequency signal propagation between said UWB module and a respective one of the other three UWB modules, and then to deduce therefrom at least one current value of the distance between said UWB module and said other UWB module, called the measured separation (Eₘ);
the signal processor (113ᵢ) comprises a memory, storing at least one actual separation value (Eᵣ), each corresponding to an actual value of the distance between said UWB module and a respective one of the other three UWB modules; and
the signal processor (113ᵢ) is configured to compute the value of a calibration distance (d_{cal}), using the at least one measured separation (Eₘ) and the at least one actual separation value (Eᵣ).

2. The set (100) as claimed in claim 1, characterized in that, in each UWB module (110₁; 110₂; 110₃; 110₄; 110ᵢ), the signal processor (113ᵢ) is configured to compute the calibration distance value (d_{cal}), using a difference between the measured separation (Eₘ) and the actual separation value (Eᵣ).

3. The set (100) as claimed in claim 1, characterized in that, in each UWB module (110₁; 110₂; 110₃; 110₄; 110ᵢ):
said memory stores a plurality of actual separation values, which respectively correspond to the actual values of the separation between said UWB module and each of the other UWB modules;
said UWB module is configured to compute a plurality of measured separations, which correspond to respective values of the distance between said UWB module and each of the other UWB modules; and
said UWB module is configured to compute the value of a calibration distance, using respective differences between a measured separation and a corresponding actual separation value, and combining said differences.

4. The set (100) as claimed in claim 1, characterized in that, in each UWB module (110₁; 110₂; 110₃; 110₄; 110ᵢ), the signal processor (113ᵢ) is configured to store said calibration distance value (d_{cal}), and to use the latter during subsequent computations of a current value of the distance between said UWB module and the keycard (300).

5. The set (100) as claimed in claim 4, characterized in that, in each UWB module (110₁; 110₂; 110₃; 110₄; 110ᵢ), the signal processor (113ᵢ) is configured to:
determine an initial calibration distance value, then use the latter as a calibration distance value, during subsequent computations of a current value of the distance between said UWB module and the keycard (300); then
determine at least one updated calibration distance value, then use the latter as a calibration distance value, during subsequent computations of a current value of the distance between said UWB module and the keycard (300).

6. The set (100) as claimed in claim 1, characterized in that each UWB module (110₁; 110₂; 110₃; 110₄; 110ᵢ) has what is called a conventional operating mode, in which it is configured to provide at least one current distance value relative to a keycard (300), and what is called a self-calibration operating mode, in which it is configured to provide a calibration distance value (d_{cal}), each UWB module further comprising a control unit (114ᵢ) configured to switch the UWB module to the self-calibration mode.

7. The set (100) as claimed in claim 1, characterized in that, in each UWB module (110₁; 110₂; 110₃; 110₄; 110ᵢ), the signal processor (113ᵢ) is configured to compare the value of a calibration distance (d_{cal}) with a predetermined threshold value, and to generate a warning signal when the value of a calibration distance is greater than said threshold value.

8. The set (100) as claimed in claim 1, characterized in that, in each UWB module (110₁; 110₂; 110₃; 110₄; 110ᵢ), the signal processor (113ᵢ) is configured to:
detect a faulty module among the UWB modules (110₁; 110₂; 110₃; 110₄; 110ᵢ) of the set, by comparing, with a predetermined threshold, a difference in absolute value between the measured separation (Eₘ) and the corresponding actual separation value (Eᵣ); and
deactivate the UWB module identified as being faulty, when the presence of a faulty module among the UWB modules (110₁; 110₂; 110₃; 110₄; 110ᵢ) of the set (100) has been detected.

9. A system for locating a user, intended to be integrated into a motor vehicle (10), and comprising a set (100) as claimed in claim 1, characterized in that it further comprises a central computer (200), connected to each of the UWB modules (110₁; 110₂; 110₃; 110₄; 110ᵢ) of the set (100), and configured to:
receive, from each respective one of said UWB modules, a current value of the distance between said UWB module and the keycard (300); and
compute, using said current distance values, a current position of the keycard (300) relative to said vehicle.

10. The system as claimed in claim 9, characterized in that said central computer (200) is further configured to lock and/or unlock at least one door of the motor vehicle (10), in particular depending on at least one current position of the keycard (300) relative to said vehicle (10).

11. The system as claimed in claim 10, characterized in that it further comprises the keycard (300), the keycard being intended to be carried by a user wishing to access the motor vehicle (10), and comprising a memory storing an authentication code.

12. A vehicle (10) comprising a set (100) as claimed claim 1.

13. A method implemented in each UWB module (110₁; 110₂; 110₃; 110₄; 110ᵢ) of a set (100) as claimed in claim 1, characterized in that it comprises the following steps:
a/ transmitting (401) the UWB-module interrogation signal (SE(i)) to at least one of the other three UWB modules and receiving (402) in return the at least one UWB-module response signal (SR(i, j));
b/ storing (403) the second timestamp data (Ti), relating to the times of transmission of the UWB-module interrogation signal and of reception of the UWB-module response signal;
c/ using the second timestamp data, computing (404) the second current time-of-flight value (Δt), corresponding to a time of radio-frequency signal propagation between said UWB module and a respective one of the other three UWB modules, and using (405) said second current time-of-flight value to compute the corresponding measured separation (Eₘ);
d/ computing a difference (406) between the measured separation (Eₘ) and the corresponding actual separation value (Eᵣ), to obtain a calibration distance value (d_{cal}); then
e/ using said calibration distance value to subsequently compute at least one current value of the distance between said UWB module and a keycard.

14. A method implemented in each UWB module (110₁; 110₂; 110₃; 110₄; 110ᵢ) of a set (100) as claimed in claim 1, characterized in that it comprises the following steps:
a/ transmitting (401) the UWB-module interrogation signal (SE(i)) to at least one of the other three UWB modules and receiving (402) in return the at least one UWB-module response signal (SR(i, j));
b/ storing (403) the second timestamp data (Ti), relating to the times of transmission of the UWB-module interrogation signal and of reception of the UWB-module response signal;
c/ using the second timestamp data, computing (404) the second current time-of-flight value (Δt), corresponding to a time of radio-frequency signal propagation between said UWB module and a respective one of the other three UWB modules, and using (405) said second current time-of-flight value to compute the corresponding measured separation (Eₘ);
d/ computing a difference (406) between the measured separation (Eₘ) and the corresponding actual separation value (Eᵣ), to obtain a calibration distance value (d_{cal}); then
e/ using said calibration distance value to subsequently compute at least one current value of the distance between said UWB module and a keycard,
wherein steps a/to d/ are implemented a plurality of times during the lifetime of the set (100) as claimed in claim 1, and in that step e/ is implemented each time using the last computed calibration distance value.

15. The method as claimed in claim 13, characterized in that it further comprises:
a step of detecting a faulty module among the UWB modules (110₁; 110₂; 110₃; 110₄; 110ᵢ) of the set (100), by comparing, with a predetermined threshold, a difference in absolute separation between the measured separation (Eₘ) and the corresponding actual separation value (Eᵣ); and
a step of deactivating the UWB module identified as being faulty, when the presence of a faulty module among the UWB modules (110₁; 110₂; 110₃; 110₄; 110ᵢ) of the set (100) has been detected.
